(19) United States
(12) Patent Application Publication
(10) Pub. No.: US 2007/0044075 A1
(43) Pub. Date: Feb. 22, 2007

(54) Method for analysis of source code and display of corresponding output through a marking scheme

(76) Inventors: Maarten Koning, Bloomfield (CA); Tomas Evensen, Foster City, CA (US); Felix Burton, San Mateo, CA (US)

Correspondence Address: FAY KAPLUN & MARCIN, LLP, 15O BROADWAY, SUITE 702, NEW YORK, NY, 10038, US

(21) Appl. No.: 11/206,725

(22) Filed: Aug. 17, 2005

(51) Int. Cl. G06F 9/44

(52) U.S. Cl. 717/122

(57) ABSTRACT

Described is receiving a segment of source code, analyzing the source code based on a performance metric, wherein the performance metric relates the source code to corresponding machine code and displaying a marked version of the source code, wherein the marked version corresponds to a value of the performance metric.

### BACKGROUND INFORMATION

Software developers often write programs using high level programming languages that constitute the source code of the programs (e.g., C++, C, Java, etc.). A developer interfaces with the source code through a source browser which allows the developer to view and edit the source code. Programs are then tested through a debugger program, which is designed to facilitate the detection of programming errors. Following this, the program is converted into machine instructions or virtual machine instructions through an assembler or compiler program. The outputted machine code can vary greatly both in length and execution time. Information regarding how the source code affects the machine code would be of significant interest to the user.

### SUMMARY OF THE INVENTION

A method including receiving a segment of source code, analyzing the source code based on a performance metric, wherein the performance metric relates the source code to corresponding machine code and displaying a marked version of the source code, wherein the marked version corresponds to a value of the performance metric.

A system including a receiving module to receive a segment of source code, an analyzer module to analyze the source code based on a performance metric, wherein the performance metric relates the source code to corresponding machine code and a display module to display a marked version of the source code, wherein the marked version corresponds to a value of the performance metric.

In addition, a system comprising a memory to store a set of instructions and a processor to execute the set of instructions, the set of instructions being operable to receive a segment of source code, analyze the source code based on a performance metric, wherein the performance metric relates the source code to corresponding machine code and display a marked version of the source code, wherein the marked version corresponds to a value of the performance metric.

Also, a method for retrieving a comparison of a current code to a previous code, wherein the comparison is based on a performance metric of the code and displaying a marked version of the code, wherein the marked version corresponds to a value of the performance metric.

### BRIEF DESCRIPTION OF THE DRAWINGS

FIG. 1 shows an exemplary marking process according to the present invention.

FIG. 2 shows an exemplary color marking process according to the present invention.

FIG. 3 is a diagram showing exemplary components of the user preferences according to the present invention.

FIG. 4 is a diagram showing exemplary components of the display/marking settings according to the present invention.

FIG. 5 is a diagram showing a set of exemplary performance metrics according to the present invention.

FIG. 6 is a diagram showing exemplary components of a set of color assignments according to the present invention.

### DETAILED DESCRIPTION

The present invention may be further understood with reference to the following description and the related appended drawings, wherein like elements are provided with the same reference numerals. The present invention is directed to a method through which source code may be analyzed and marked (e.g., color coded) according to a set of user preferences in such a way as to enable a user to understand a complexity and a length of a machine code that will be generated by the source code. In particular, this method will allow users to quickly navigate to complex code areas and identify hidden costs associated with certain source coding techniques. The method of the present invention is directed towards use with a source code browser, and may also be used in conjunction with, or integrated into, a debugger program, a software compiler, a software assembler, a source code editor, or any program which combines these elements. The present invention may also be implemented with any source code and is not limited to any particular source code language or compiler/assembler. Moreover, while the exemplary embodiments are described with reference to source code, it is also possible to implement the present invention with reference to any type of generated code (e.g., assembler code).

As known to those skilled in the art, a complexity of a machine code that constitutes a body of a software program may be characterized by a length of the program (i.e., a total number of instructions) and an execution time (i.e., a total number of clock cycles) of the program. The complexity of the machine code may be directly or indirectly related to a complexity of the source code that generates the machine code. In order to understand the complexity of the machine code, a user must therefore understand the complexity of the source code that generates it. However, this is difficult to do with high level programming languages that contain elements such as macros, inline functions, operator overloading, temporary object creation, etc. A conventional alternative to viewing source code in a browser or editor is for the user to use a mixed source/assembler view. However, this method makes browsing difficult, especially for large programs. The present invention seeks to overcome this disadvantage by allowing users to quickly discern the complexity of source code from directly within the source browser/editor.

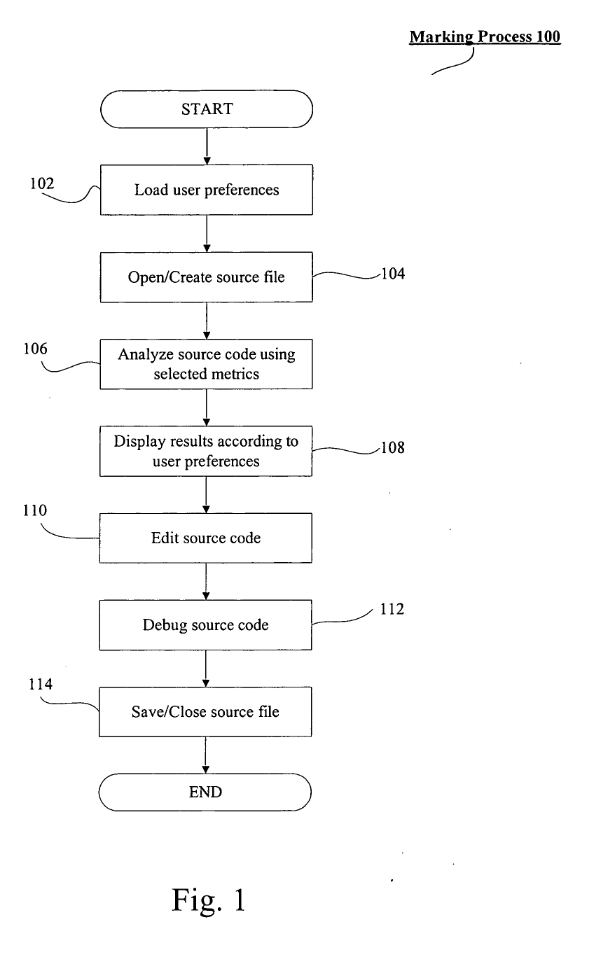

FIG. 1 shows an exemplary embodiment of a marking process 100 and the corresponding steps taken in an implementation of the present invention. Initially, the user's preferences, which may include a set of marking preferences are loaded upon start of the process 100 (step 102). If no user preferences have been previously set, a default set of user preferences may be loaded. The marking preferences may include, for example, a color code or scale which will be used to mark or highlight areas of the source code. Other examples of the marking preferences may include the use of grey scale or other methods of highlighting source code. Other types of marking may also include style changes such as font size, bolding, italics, etc. In addition, three-dimensional coding may be provided. The marking preferences may also be related to a set of performance metrics (e.g., complexity level) which will be used to determine the source code to be marked for the user. Examples of marking and the performance metrics will be described in greater detail below.

After the preferences are loaded, the user may choose to create a new source code file or open an existing source file (step 104). If the source file already exists or after a source file has been written, the file will be analyzed based on the selected performance metrics (step 106). It should be noted that the analysis may be performed at some prior time and the results of the analysis may be stored in, for example, a database for later display to the user. The results of this analysis will be displayed in, for example, the source browser based on the user preferences (step 108). The displayed results will be marked or highlighted source code based on the selected performance characteristics. An example of the displayed results may be source code which is color coded according to the performance metrics.

The user may edit the source code based on the displayed results (steps 110). The source code may then be debugged (step 112). It should be noted that although the results are initially displayed within the source browser, they may also be imported into, and displayed within, the debugger. Such an implementation would represent a further embodiment of the invention. After the user has completed editing and debugging of the source code, the source file is saved and closed (step 114).

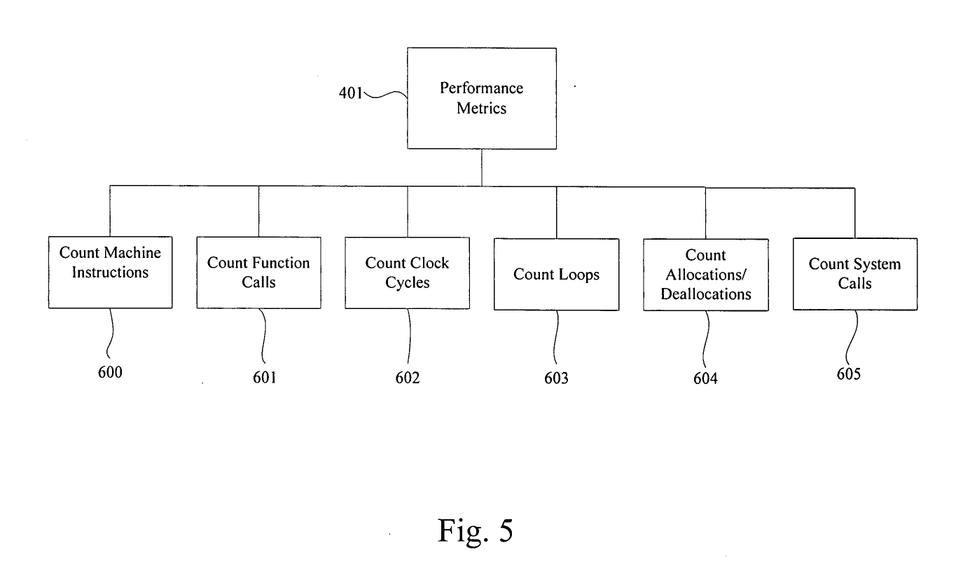

In an exemplary embodiment of the invention, the marking information is updated once in accordance with the user preferences. However, the user may analyze the source code multiple times as the source code is edited and/or changed. Moreover, the analysis may be set to be performed automatically on a periodic basis (e.g., time based and/or usage based). The user preferences are based upon the particular performance metrics used to calculate the complexity of the source code. As shown in FIG. 5, these performance metrics may include, but are not limited to, the number of machine instructions per line of source code 600, the number of function calls emitted per line of source code 601, the number of clock cycles for the machine code generated per line of source code 602, the number of loop constructs generated per line of source code 603, the number of dynamic memory allocations/deallocations made per line of source code 604, and the number of system calls generated per line of source code 605. Additional metrics may include, for example, a number of cache hits and misses, the changes in any of the described metrics based on the changes in the code (e.g., code deltas), etc.

In addition, the performance metrics need not be limited to the specifics of the complexity of the source code. In another embodiment of the invention, users may be presented with information based upon an actual runtime of the generated machine code. Such information would provide an accurate analysis of the complexity of the source code as evaluated on a specific hardware/software platform combination determined by a compiler/assembler, an operating system, a hardware configuration, etc.

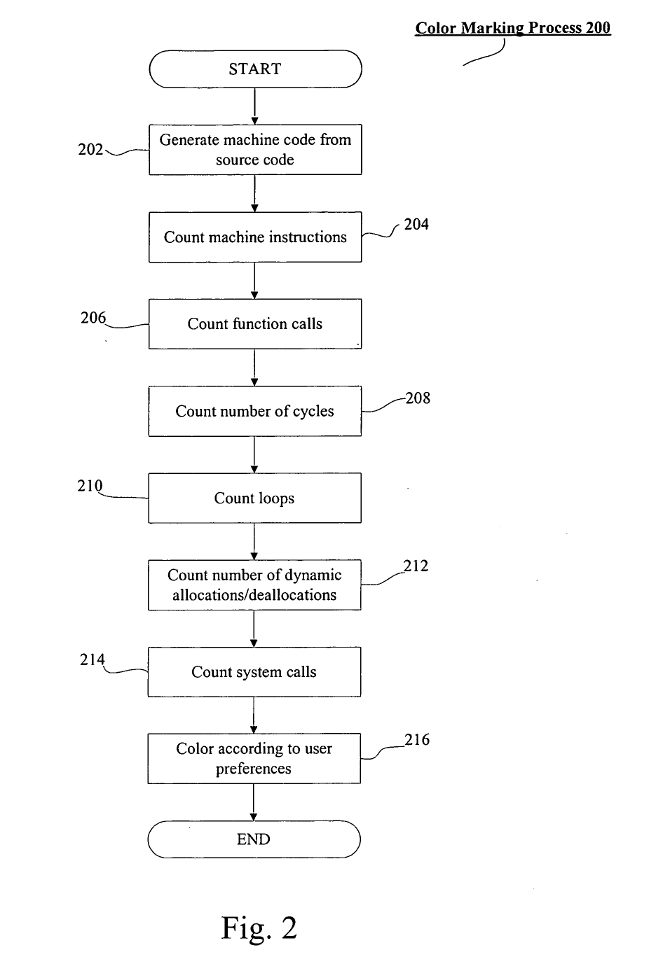

FIG. 2 shows an exemplary color marking process 200. The process 200 amplifies steps 106 and 108 of the marking process 100 of FIG. 1. In this exemplary process 200, the user has selected a color coding of source code based on each of the performance metrics described with reference to FIG. 5. In step 202, the machine code is generated from the source code. Each of steps 204-214 analyze the machine code/source code for the selected performance metrics. The order in which the analysis for metrics is completed is irrelevant, and their order as presented in FIG. 2 should be understood to be exemplary. In addition, the user may select each performance metric for which the code should be analyzed (e.g., one, several, or all of the performance metrics may be selected). Thus, only selected ones of steps 204-214 may be completed.

The analysis steps 204-214 proceed by running through the source code and detecting the presence and boundaries of functions, blocks, loops, and other code elements within the body of the source code. For each identified element, a count is performed for each of the selected metrics for which the element is applicable. For example, if a user-defined function is identified, and the count function calls metric 601 is selected, the analysis step 206 iterates through the machine code corresponding to the user-defined function and counts the number of function calls.

After the selected analysis steps are completed, the coloring step is initiated (step 216). The coloring step will mark a line or lines of the source code based on the selected performance metrics. In an example where the performance metric is the number of machine instructions 600, the user may have selected a preference where a line of source code which generates more than six (6) machine instructions is colored red, a line of source code which generates three (3) to six (6) machine instructions is colored yellow, and a line of source code which generates less than three (3) machine instructions retains its original coloring (e.g., black). Thus, in step 216, the source code will be colored based on this exemplary color coding for the selected performance metric. The source code will then be displayed to the user in the source viewer with the corresponding color coding.

Those of skill in the art will understand that if multiple performance metrics are analyzed a single line of code may be colored differently based on the different performance metrics. Thus, when analyzing multiple performance metrics, the user may set a preference such that a particular performance metric has a higher priority and therefore the color coding for this performance metric will take priority over another performance metric. In another exemplary embodiment, the process 100 may generate multiple views, where each view corresponds to a particular performance metric. Thus, the user can switch between multiple views to see the effect of the source code on the machine code based on the various performance metrics. In still another embodiment, a performance metric may be associated with an alternate manner of marking. For example, a first analyzed performance metric may be associated with color coding, while a second analyzed performance metric may be associated with shading of the source code line.

The generated machine code depends in part upon the specific algorithms used by the compiler/assembler. In order to provide accurate calculations of complexity, the present invention would therefore necessarily have knowledge of the processes through which the compiler/assembler generates machine code. This suggests that exemplary embodiments of the invention may either be embedded within the compiler/assembler itself (if the compiler also contains a source browser), or may be run as a separate program. An embodiment of the invention as a separate program may potentially contain information allowing for the analysis of performance metrics for any number of compiler and assembler programs.

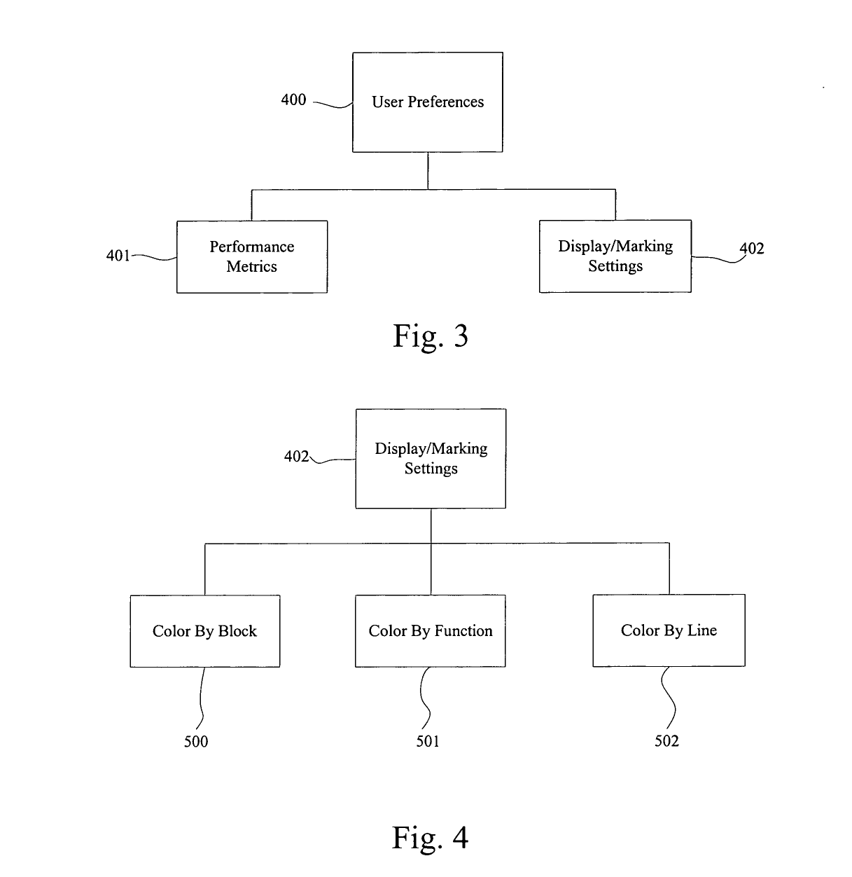

FIG. 3 shows an exemplary embodiment of a set of user preferences 400 which may include a performance metrics component 401 and a display/marking settings component 402. Once configured by the user, the user preferences 400 are used to display the results of the code analysis according to the specifications of the user.

FIG. 4 shows an exemplary embodiment of the display/marking settings 402 when the preferences are stored as color settings. The display/marking settings 402 include color by block 500, color by function 501, and color by line 502 components. Thus, the example of FIG. 4 shows that coloring may not be limited to specific lines of source code, but may also encompass larger segments of code (e.g., blocks, functions, etc.).

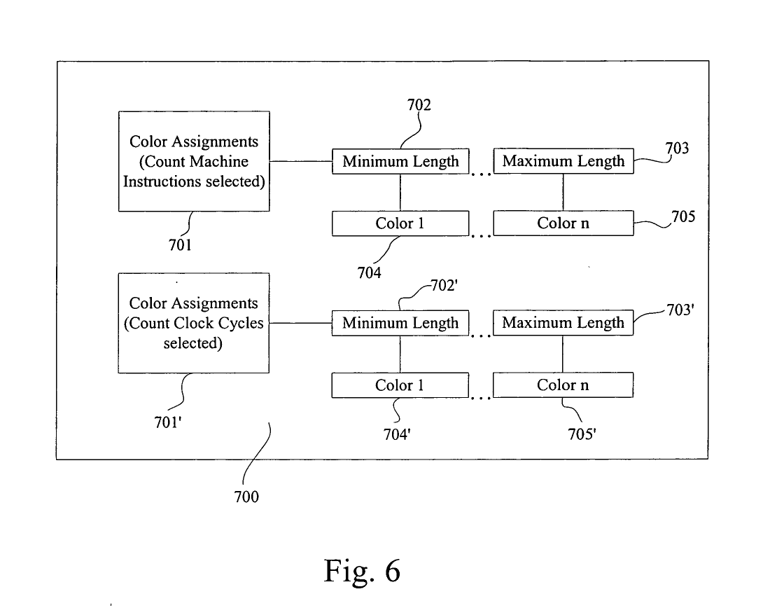

FIG. 6 shows an exemplary embodiment of a color assignment mapping 700. For a given color assignment 701 & 701′, there may be a minimum length 702 & 702′ with corresponding color selections 704 & 704′ and a maximum length 703 & 703′ with corresponding color selections 705 & 705′. For every possible metric value within a user-defined range, there is a one-to-one correspondence between the value and a user-defined color. For instance, the user might select green for a minimum length 702 of three (3) instructions, and red for a maximum length 703 of ten (10) instructions, all while having selected the color by block 500 option. As described in the example above, there may also be intermediate settings.

The method by which the user inputs the color assignments may be graphical (e.g., through a graphical user interface menu), text prompt based (e.g., through direct input of RGB color values), or a combination of both. Therefore, while the color scheme may be as simple as having two unique color values mapped to a maximum/minimum value pair, an advanced user may have any number of values mapped to various distinct colors and varying shades of those colors. The only practical limit to the number of colors displayed would be the ability of the user to distinguish between the colors.

The coloring process correlates the analysis results to the display/marking settings 402 by displaying the results according to the color scheme specified by the user. For example, a selection of color by block 500 would take the analysis results, compare them to the color assignment mapping 700 selected by the user, and color each identified block of code within the source code using the correlated color value. Similarly, selection of color by line 502, and color by function 501 would take the analysis results, compare them to the color assignment mapping 700 selected by the user, and color each identified line and block, respectively of code within the source code using the correlated color values.

It will be apparent to those skilled in the art that various modifications may be made in the present invention, without departing from the spirit or scope thereof. Thus, it is intended that the present invention cover the modifications and variations of this invention provided they come within the scope of the appended claims and their equivalents.

What is claimed is:

1. A method, comprising:
receiving a segment of source code;
analyzing the source code based on a performance metric, wherein the performance metric relates the source code to corresponding machine code; and
displaying a marked version of the source code, wherein the marked version corresponds to a value of the performance metric.

2. The method of claim 1, wherein the marked version includes a color coding of at least one line of the source code.

3. The method of claim 1, wherein the segment of source code includes one of a line of source code, a block of source code, a function of source code, a module of source code, and a complete program of source code.

4. The method of claim 1, wherein the performance metric is one of a number of machine instructions, a number of function calls, a number of clock cycles, a number of loop constructs, a number of dynamic memory allocations and deallocations, a number of system calls, a number of cache hits and a number of cache misses.

5. The method of claim 1, wherein the marked version is displayed on a source viewer.

6. The method of claim 1, further comprising:
editing the source code; and
repeating the analyzing and displaying steps for the edited source code.

7. The method of claim 1, further comprising:
debugging the source code.

8. The method of claim 1, wherein the value of the performance metric is indicative of a complexity of the machine code.

9. The method of claim 1, wherein the value includes a first value corresponding to a first marking and a second value corresponding to a second marking.

10. The method of claim 9, wherein the first marking is a first color and the second marking is a second color.

11. The method of claim 1, wherein the marked version includes one of color shading, grey scale shading, and highlighting.

12. The method of claim 1, further comprising:
receiving a user preference, wherein the user preference includes one of the performance metric, the value, and a marking preference.

13. A system, comprising:
a receiving module to receive a segment of source code
an analyzer module to analyze the source code based on a performance metric, wherein the performance metric relates the source code to corresponding machine code; and
a display module to display a marked version of the source code, wherein the marked version corresponds to a value of the performance metric.

14. The system of claim 13, wherein the marked version includes a color coding of at least one line of the source code.

15. The system of claim 13, wherein the performance metric is one of a number of machine instructions, a number of function calls, a number of clock cycles, a number of loop constructs, a number of dynamic memory allocations and deallocations, a number of system calls, a number of cache hits and a number of cache misses.

16. The system of claim 13, wherein the marked version is displayed on a source viewer.

17. The system of claim 13, further comprising:
a preference module to receive a user preference, wherein the user preference includes one of the performance metric, the value, and a marking preference.

18. The system of claim 13, wherein the system is included as a portion of one of a source code browser, a debugger program, a software compiler, a software assembler, and a source code editor.

19. The system of claim 13, wherein the performance metric includes a plurality of performance metrics.

20. A system comprising a memory to store a set of instructions and a processor to execute the set of instructions, the set of instructions being operable to:
receive a segment of source code;
analyze the source code based on a performance metric, wherein the performance metric relates the source code to corresponding machine code; and
display a marked version of the source code, wherein the marked version corresponds to a value of the performance metric.

21. A method, comprising:
retrieving a comparison of a current code to a previous code, wherein the comparison is based on a performance metric of the code; and
displaying a marked version of the code, wherein the marked version corresponds to a value of the performance metric.
